(19) United States
(12) Patent Application Publication
(10) Pub. No.: US 2010/0051700 A1
(43) Pub. Date: Mar. 4, 2010

(54) RADIO APPARATUS, ANTENNA DEVICE AND RADIO COMMUNICATION SYSTEM FOR CONTACTLESS COMMUNICATION

(75) Inventors: Takashi MINEMURA, Tokyo (JP); Hiroshi WATANABE, Tokyo (JP); Akihiro TSUJIMURA, Tokyo (JP); Hiromichi SUZUKI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/356,690

(22) Filed: Jan. 21, 2009

(30) Foreign Application Priority Data
Sep. 2, 2008 (JP) 2008-224845

(51) Int. Cl. G06K 19/06

(52) U.S. Cl. 235/492

(57) ABSTRACT

A radio apparatus configured to perform contactless communication with an external device having a first antenna, upon being arranged opposite the external device, is provided. The radio apparatus includes a case, a second antenna and a conductive element. The case has an outer face arranged opposite the external device upon the radio apparatus being arranged opposite the external device. The second antenna is provided in the case, and at least partially arranged parallel to the outer face. The conductive element is arranged close to and electrically coupled with the first antenna, upon the case being positioned opposite the external device so that the contactless communication may be performed.

### CROSS REFERENCE TO RELATED APPLICATIONS

This application is based upon and claims the benefit of priority from the prior Japanese Patent Application No. 2008-224845 filed on Sep. 2, 2008; the entire contents of which are incorporated herein by reference.

### BACKGROUND OF THE INVENTION

1. Field of the Invention

The present invention relates to a radio apparatus, an antenna device and a radio communication system, and in particular to a radio apparatus, an antenna device and a radio communication system adapted for contactless communication.

2. Description of the Related Art

Wireless communication technology applied to identification is called radio frequency identification (RFID), and is widely used for automatic ticket gates, working hour management of companies and offices, various kinds of electronic money and so on. In an RFID system, information is transferred from a device called a reader/writer to a data medium called a card or a tag, and vice versa. These days, mobile phones of some types are equipped with RFID, covering a card function at the beginning and then covering a reader/writer function.

In the RFID system, the reader/writer and the card have a built-in antenna each. The antennas of the reader/writer and of the card are opposite each other in a contactless manner and given a condition in which a data transfer is available, so that the reader/writer may write data onto the card and may read data out of the card. The antennas of the RFID system are generally of a loop-shaped coil type.

Apart from the RFID system, vehicle-mounted or broadcast receiving systems may use an antenna including a loop-shaped element. It is important that the antenna of such systems have a broadband characteristic, as disclosed in, e.g., Japanese Patent Publication of Unexamined Applications (Kokai), No. 2007-67884 or No. 2006-295545.

The antenna disclosed in JP 2007-67884 includes a one-wavelength loop antenna and a half-wavelength parasitic element which are resonant at different frequencies. The parasitic element is arranged to be laid across two feed terminals of the loop antenna.

The antenna disclosed in JP 2006-295545 includes a double loop formed by two loop-shaped elements of different sizes, and a parasitic element arranged close to and opposite a side of the double loop including a feed point.

Incidentally, the loop-shaped antenna included in the reader/writer described above forms a resonator, and so does the loop-shaped antenna included in the card. The resonators of the reader/writer and of the card are set to have a same nominal resonant frequency (named f0). It is generally known, however, that as two resonators having a same nominal resonant frequency approach each other, the resonant frequencies of the resonators gradually become separate so that two resonant frequencies f1 and f2 appear (f1<f0<f2), as disclosed by Kawaguchi, et al., and by Ito, et al.

Refer to Kawaguchi, Kobayashi and Ma, “A Study on Equivalent Circuit Expression of Electromagnetic Coupling between Distributed Resonators”, Technical Report of IEICE, EMCJ2003-78, MW2003-175, October 2003.

Refer to Ito, Minemura and Amano, “Correlation between Null Zone and Coupling Coefficient of HF band RFID”, Proceedings of the IEICE General Conference, No. B-1-143, March 2007.

The above phenomenon is called a frequency split that may occur between two parties such as a reader/writer and a card of an RFID system which perform contactless communication through a magnetic field, or such as two monopole antennas which perform contactless communication through an electric field. The frequency split may occur if a space between the two parties decreases to less than a certain value and a coupling between the two parties becomes strong.

It is explained, from a viewpoint of physics, that if the two resonators arranged close to each other were resonant at a same frequency, energy would reciprocally transfer between the resonators in a manner inconsistent with the second law of thermodynamics. The frequency split occurs in order to avoid such a paradox and to make energy transfer relations stable.

In some cases, if a value of the frequency split exceeds a certain limit, the reader/writer may not perform communication with the card. This phenomenon is caused by a reduced Q-value, a reduced output voltage and increased internal thermal noise of an amplifier. The reductions of the Q-value and the output voltage are caused by a deviation of the resonant frequency from the nominal value. The increase of the internal thermal noise is caused by a mismatch of noise figures between the resonator and the amplifier of a later stage.

It is intended that the antennas disclosed in JP 2007-67884 and JP 2006-295545 may expand application areas by using broadband characteristics of the loop antennas. It is not considered, however, that antennas of radio apparatuses such as a reader/writer and a card of an RFID system arranged close to each other may cause a problem of a frequency split.

### SUMMARY OF THE INVENTION

Accordingly, an advantage of the present invention is to suppress a frequency split caused by antennas facing and arranged close to each other for performing contactless communication so as to make the communication stable.

To achieve the above advantage, one aspect of the present invention is to provide a radio apparatus configured to perform contactless communication with an external device having a first antenna, upon being arranged opposite the external device, is provided. The radio apparatus includes a case, a second antenna and a conductive element. The case has an outer face arranged opposite the external device upon the radio apparatus being arranged opposite the external device. The second antenna is provided in the case, and at least partially arranged parallel to the outer face. The conductive element is arranged close to and electrically coupled with the first antenna, upon the case being positioned opposite the external device so that the contactless communication may be performed.

### BRIEF DESCRIPTION OF THE DRAWINGS

FIG. 1 is a perspective view showing a configuration of a mobile communication apparatus of a first embodiment of the present invention.

FIG. 2 is a perspective view of the mobile communication apparatus of the first embodiment showing a first section and a second section being closed to each other.

FIG. 3 is a perspective view showing a configuration of an antenna of the first embodiment to be used for an RFID system and contained in the first section, and relative positions among portions layered inside the first section.

FIG. 4 is an explanatory diagram showing the mobile communication apparatus of the first embodiment arranged opposite an external reader/writer.

FIG. 5 is a perspective view showing relative positions among the portions of the mobile communication apparatus of the first embodiment and an antenna of the reader/writer.

FIG. 6 is a plan view showing a first example of relative positions among the antenna and conductive elements of the mobile communication apparatus of the first embodiment and the antenna of the reader/writer.

FIG. 7 is a plan view showing a second example of relative positions among the antenna and conductive elements of the mobile communication apparatus of the first embodiment and the antenna of the reader/writer.

FIG. 8 is a plan view showing a third example of relative positions among the antenna and conductive elements of the mobile communication apparatus of the first embodiment and the antenna of the reader/writer.

FIG. 9 is a plan view showing a fourth example of relative positions among the antenna and conductive elements of the mobile communication apparatus of the first embodiment and the antenna of the reader/writer.

FIG. 10 is a plan view showing a fifth example of relative positions among the antenna and conductive elements of the mobile communication apparatus of the first embodiment and the antenna of the reader/writer.

FIG. 11 is a plan view showing a sixth example of relative positions among the antenna and conductive elements of the mobile communication apparatus of the first embodiment and the antenna of the reader/writer.

FIG. 12 is a plan view showing a seventh example of relative positions among the antenna and conductive elements of the mobile communication apparatus of the first embodiment and the antenna of the reader/writer.

FIG. 13 is a plan view showing an eighth example of relative positions among the antenna and conductive elements of the mobile communication apparatus of the first embodiment and the antenna of the reader/writer.

FIG. 14 is a plan view showing a ninth example of relative positions among the antenna and conductive elements of the mobile communication apparatus of the first embodiment and the antenna of the reader/writer.

FIG. 15 is a plan view showing a tenth example of relative positions among the antenna and conductive elements of the mobile communication apparatus of the first embodiment and the antenna of the reader/writer.

FIG. 16 is a plan view showing an eleventh example of relative positions among the antenna and conductive elements of the mobile communication apparatus of the first embodiment and the antenna of the reader/writer.

FIG. 17 is an example of a measured frequency characteristic of an S-parameter (S11) of a resonant circuit alone of the reader/writer of the first embodiment.

FIG. 18 is an example of a measured frequency characteristic of an S-parameter (S11) of a resonant circuit alone of the mobile communication apparatus of the first embodiment.

FIG. 19 is an example of a measured frequency characteristic of S11 of the mobile communication apparatus of the first embodiment with no magnetic material sheet.

FIG. 20 is an example of a measured frequency characteristic of S11 of the mobile communication apparatus of the first embodiment with a magnetic material sheet and no conductive elements.

FIG. 21 is an example of a measured frequency characteristic of S11 of the mobile communication apparatus of the first embodiment with the magnetic material sheet and conductive elements.

FIG. 22 is a perspective view showing relative positions among portions of a mobile communication apparatus of a second embodiment of the present invention and an antenna of a reader/writer.

FIG. 23 is a plan view showing relative positions among an antenna and conductive elements of the mobile communication apparatus of the second embodiment and an antenna of the reader/writer.

### DETAILED DESCRIPTION OF THE INVENTION

Hereinafter, embodiments of the present invention will be described in detail. In following descriptions, terms such as upper, lower, left, right, horizontal or vertical used while referring to a drawing shall be interpreted on a page of the drawing unless otherwise noted. A same reference numeral given in no less than two drawings shall represent a same member or a same portion.

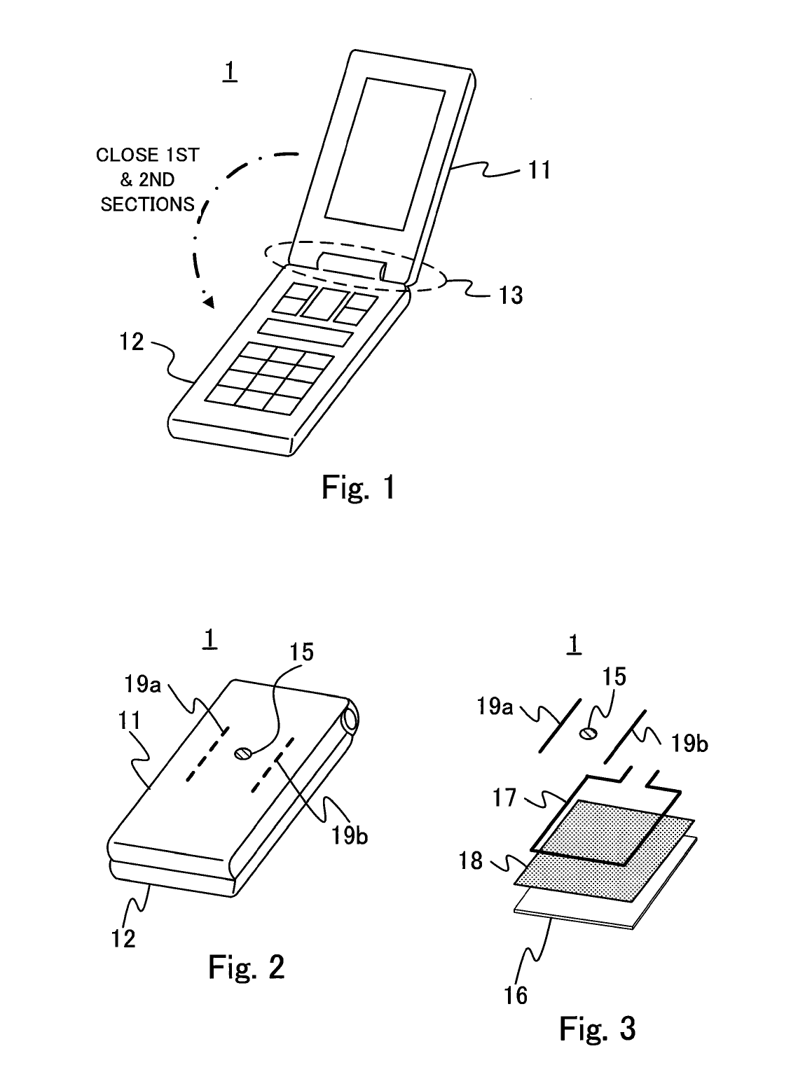

A first embodiment of the present invention will be described with reference to FIGS. 1-21. FIG. 1 is a perspective view showing a configuration of a mobile communication apparatus 1, i.e., a radio apparatus of the first embodiment. The mobile communication apparatus 1 includes a first section 11 and a second section 12 pivotally connected by a hinge section 13. FIG. 1 shows a side of the mobile communication apparatus 1 facing a user while the first section 11 and the second section 12 are being open to each other so as to be used by the user.

The first section 11 and the second section 12 may be open or closed to each other, forming a flip type structure, a dual-axis hinge (double swivel) type structure and so on (not limited to the above structures). The hinge section 13 is arranged between the first section 11 and the second section 12, and includes a mechanism configured to open or close the first section 11 and the second section 12 to each other. The hinge section 13 is shown as surrounded by a dashed ellipse in FIG. 1. As shown by a dot-and-dash arc with an arrow in FIG. 1, the first section 11 may be rotated against the second section 12 around the hinge section 13 so that the first section 11 and the second section 12 are closed to each other.

The first section 11 is provided with a display formed by, e.g., a liquid crystal device on a front face (a face opposite the user in FIG. 1) of the first section 11 (the first section 11 may be provided with another display on another face of the first section 11, such as a back face, and so may be the second section 12). The second section 12 is provided with an operation section formed by a plurality of operation keys on a front face of the second section 12 (some of the operation keys may be provided on another face such as a side face of the first section 11 or of the second section 12).

FIG. 2 is a perspective view of the mobile communication apparatus 1 showing the first section 11 being closed to the second section 12 as shown by the dot-and-dash arc in FIG. 1 from the same viewpoint as in FIG. 1. Each of portions given the reference numerals 1, 11 and 12 in FIG. 2 is a same as the corresponding one given the same reference numeral in FIG. 1. As shown in FIG. 2, a mark 15 is provided on a rear face of the first section 11 (i.e., an outer design face that is a back of the front face described above, directed outwards from the first section 11). As shown by dashed lines in FIG. 2, conductive elements 19a and 19b, which will be explained later with reference to FIG. 3, are provided on an inner back face of the rear face of the first section 11 (i.e., a face directed towards the inside of the first section 11).

FIG. 3 is a perspective view showing a configuration of an antenna contained in the first section 11 to be used for a radio frequency identification (RFID) system, and relative positions among portions layered inside the first section 11, from the same viewpoint as in FIG. 1. The first section 11 contains a printed board 16, an antenna 17 and a magnetic material sheet 18. In other words, the printed board 16, the antenna 17 and the magnetic material sheet 18 are provided in the first section 11. The printed board 16 includes a circuit corresponding to various functions (including an RFID function).

The antenna 17 is loop-shaped to be used for the RFID function, and is loaded with a lumped constant element at an end so as to form a resonant circuit having, e.g., a nominal resonant frequency of 13.56 megahertz (MHz). The above resonant circuit including the antenna 17 is connected to a circuit corresponding to the RFID function, provided in the printed board 16 and not shown. The shape of the above “loop” may be rectangular, polygonal, circular, elliptical, and so on.

The antenna 17 may be formed by, e.g., a conductive pattern of a flexible printed board, or by using another method. The antenna 17 is entirely or at least partially arranged parallel to the rear face of the first section 11. The term “parallel” used here and hereafter means not exactly but almost parallel as well as exactly parallel.

The magnetic material sheet 18 is arranged between the antenna 17 and the printed board 16. The magnetic material sheet 18 may reduce eddy current loss caused by a magnetic field and affecting a conductive pattern of the printed board 16 or a metallic portion of the first section 11, if the antenna 17 is excited. The mark 15 explained above with reference to FIG. 2 and the conductive elements 19a and 19b are shown above the antenna 17 in FIG. 3. The mark 15 is provided on the rear face of the first section 11 (not shown in FIG. 3). The conductive elements 19a and 19b are made of conductive material, shaped as a line or a plane, and, e.g., plated or stuck to the inner back face of the rear face of the first section 11. The conductive elements 19a and 19b are parasitic elements connected to no other circuits or elements.

The conductive elements 19a and 19b may be plated or stuck to the rear face of the first section 11, or may be formed, e.g., as conductor patterns of a flexible printed circuit and arranged between the antenna 17 and the magnetic material sheet 18. The conductive elements 19a and 19b may be stuck, e.g., to the magnetic material sheet 18.

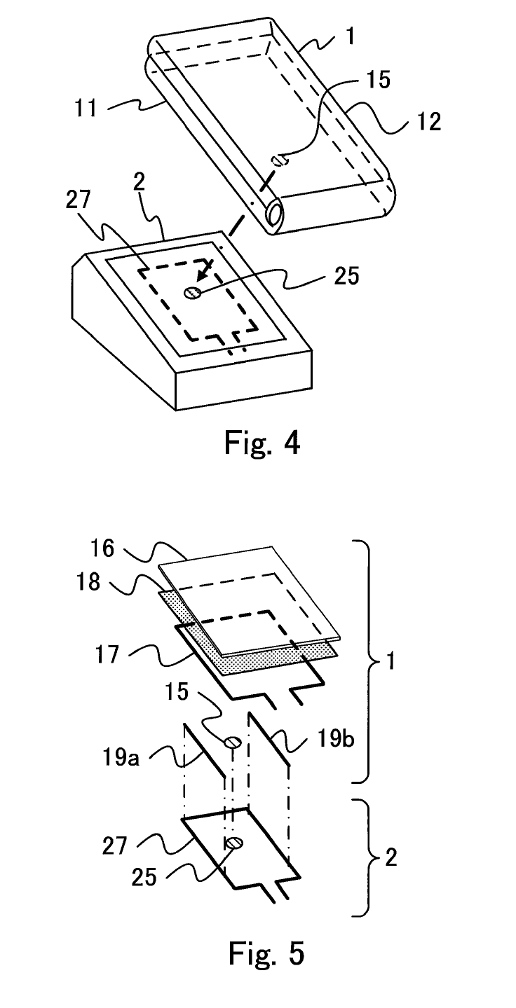

FIG. 4 is an explanatory diagram showing the mobile communication apparatus 1 arranged opposite an external reader/writer in a case where the RFID function of the mobile communication apparatus 1 is used. Directing the rear face of the first section 11 downwards, the mobile communication apparatus 1 is arranged opposite a reader/writer 2.

In order to give the mobile communication apparatus 1 a positioning target of the reader/writer 2, a mark 25 is provided in correspondence with the mark 15 of the mobile communication apparatus 1 provided on an upper face of the reader/writer 2. As shown by a dot-and dash line with an arrow in FIG. 4, the mobile communication apparatus 1 may approach the reader/writer 2 in such a way that the mark 15 overlaps the mark 25 of the reader/writer 2. In an auxiliary way of positioning, the mobile communication apparatus 1 may have a mechanical guide (not shown) so as to face and approach the reader/writer 2 at a determined position.

The reader/writer 2 includes an antenna 27 shown by a dashed line. If the mobile communication apparatus 1 is close to the reader/writer 2, the antenna 27 may be used for contactless communication with the antenna 17 of the mobile communication apparatus 1 through electromagnetic induction.

The antenna 27 has a loop-shaped antenna element, and is loaded with a lumped constant element that is not shown at a connection end so as to form a resonant circuit having, e.g., a nominal resonant frequency of 13.56 MHz. The above resonant circuit including the antenna 27 is connected to a circuit corresponding to the RFID function and not shown.

The antenna 27 may be formed by, e.g., a conductive pattern of a flexible printed board, or by using another method. The antenna 27 is entirely or at least partially arranged parallel to the rear face of the first section 11, if the mobile communication apparatus 1 is arranged opposite the reader/writer 2 as shown in FIG. 4.

FIG. 5 is a perspective view showing relative positions among the portions of the mobile communication apparatus 1 and the antenna 27 of the reader/writer 2 in the same arrangement as shown in FIG. 4. Each of portions shown in FIG. 5 is a same as the corresponding one given the same reference numeral shown in FIG. 3 or FIG. 4.

It is assumed that a relative position between the mobile communication apparatus 1 and the reader/writer 2 is determined in such a way that the marks 15 and 25 meets each other as shown by a vertical dot-and dash line in FIG. 5. Then, the conductive elements 19a and 19b overlap a portion of the antenna 27, as shown by other vertical dot-and dash lines in FIG. 5. Thus, upon the mobile communication apparatus 1 and the reader/writer 2 being arranged close to each other in the relative position as determined above, the conductive elements 19a and 19b may be electrically coupled to the antenna 27 each.

Unless the conductive elements 19a and 19b are provided, as in the related art, as the resonant circuits of the mobile communication apparatus 1 and the reader/writer 2 including the antennas 17 and 27, respectively, have the same nominal resonant frequency, the contactless communication between the mobile communication apparatus 1 and the reader/writer 2 may be disturbed by the frequency split described with respect to the related art.

Meanwhile, if the conductive elements 19a and 19b are electrically coupled to the antenna 27 each in the arrangement shown in FIG. 5, energy transferred between the antennas 17 and 27 through the electromagnetic induction is partially dissipated as eddy current loss. The antennas 17 and 27 may consequently be less strongly coupled to each other so as to suppress the frequency split.

In FIG. 5, an upper and lower relation between the antenna 17 and the conductive elements 19a and 19b may be inverted in some cases, in a same manner as described with reference to FIG. 3. At any rate, the conductive elements 19a and 19b are arranged between the antenna 27 and the magnetic material sheet 18.

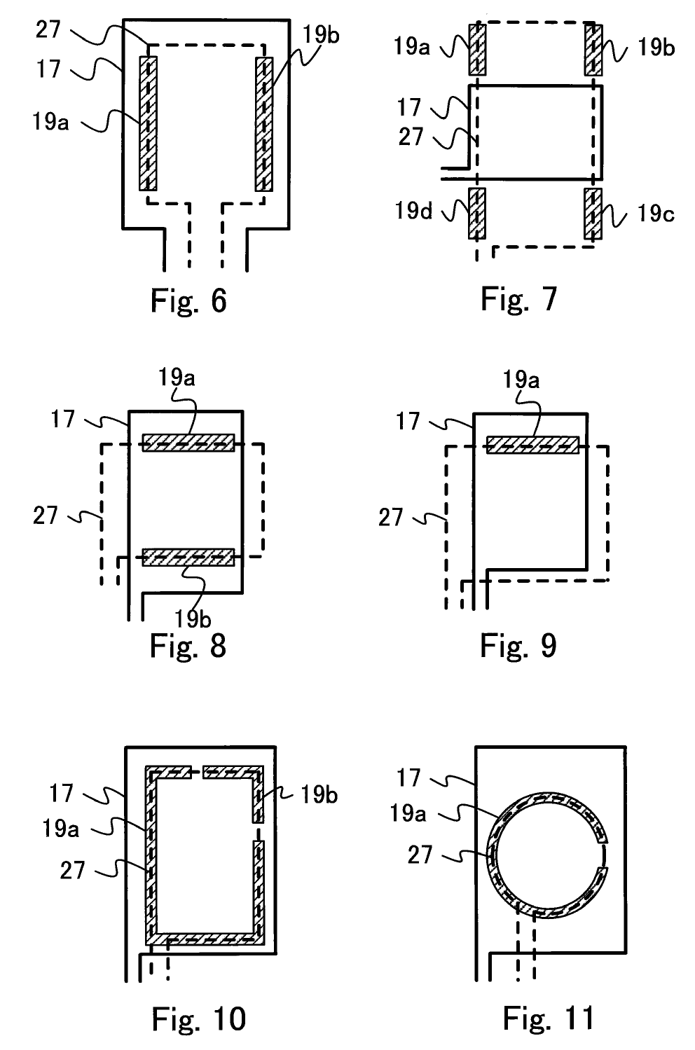

FIG. 6 is a plan view showing relative positions among the antenna 17, the conductive elements 19a and 19b, and the antenna 27 shown in FIG. 5 as viewed from just above the printed board 16 in FIG. 5 (i.e., the antenna 27 is viewed from the antenna 17 in a direction vertical to the rear face of the first section 11). In FIG. 6 (and also in following FIGS. 7-16), the connection ends of the antennas 17 and 27 may be fed through the resonant circuits including the lumped constant element that is not shown.

As shown in FIG. 6, the conductive elements 19a and 19b look like at least partially overlapping the antenna 27 each. And the conductive elements 19a and 19b look at least partially separate from the antenna 17 each.

As the conductive elements 19a and 19b are arranged to look like overlapping the antenna 27, the energy transferred between the antennas 17 and 27 through the electromagnetic induction is partially dissipated as the eddy current loss of the conductive elements 19a and 19b, so that the frequency split between the antennas 17 and 27 may be effectively suppressed.

The conductive elements 19a and 19b have to be sized large enough to cause a significant level of the eddy current loss. In a case of a mobile communication apparatus equipped with an RFID function, sizes of the conductive elements 19a and 19b are limited to around one thousandth to one hundredth wavelength. Whether such a size is so significant that the frequency split may be effectively suppressed will be explained later with reference to experimental examples.

As the conductive elements 19a and 19b are arranged to look separate from the antenna 17, cost of degradation of the antenna characteristic may be imposed not on the card side (the mobile communication apparatus 1) but on the reader/writer side (reader/writer 2). As the reader/writer may ordinarily provide greater power than the card, it is easier to compensate the degradation of the antenna characteristic on the reader/writer side than on the card side.

As being arranged between the antenna 27 and the magnetic material sheet 18, the conductive elements 19a and 19b may avoid reduction of their effect on the antenna 27 caused by an electromagnetic isolation effect of the magnetic material sheet 18. The magnetic material sheet 18 may ordinarily have less degree of freedom of its shape or area so as to maintain performance of the antenna 27. If the antenna 27 is larger than the antenna 17, the magnetic material sheet 18 has to be larger than the antenna 17 so as to reduce the effect of the antenna 27. If that is the case, a far magnetic field of the antenna 17 will be disturbed, and a spatial communication range of the antenna 17 will be much reduced. Preventing such a case, the conductive elements 19a and 19b have an effect to maintain the spatial communication range and to suppress an excessive coupling with the antenna 27 being arranged close to the antenna 17.

FIG. 7 is a plan view showing an example of relative positions among the antenna 17, four conductive elements 19a-19d and the antenna 27 in a same manner as in FIG. 6. The conductive elements 19a-19d look like at least partially overlapping the antenna 27 each. And the conductive elements 19a-19d look at least partially separate from the antenna 17 each.

FIG. 8 is a plan view showing an example of relative positions among the antenna 17, two conductive elements being long sideways 19a and 19b and the antenna 27 in a same manner as in FIG. 6. The conductive elements 19a and 19b look like at least partially overlapping the antenna 27 each. And the conductive elements 19a and 19b look at least partially separate from the antenna 17 each.

FIG. 9 is a plan view showing an example of relative positions among the antenna 17, one conductive element being long sideways 19a and the antenna 27 in a same manner as in FIG. 6. The conductive element 19a looks like at least partially overlapping the antenna 27. And the conductive element 19a looks at least partially separate from the antenna 17.

FIG. 10 is a plan view showing an example of relative positions among the antenna 17, two conductive elements 19a and 19b forming a loop having opened portions, and the antenna 27 in a same manner as in FIG. 6. As an area surrounded by the loop formed by the conductive elements 19a and 19b is smaller than an area surrounded by the loop formed by the antenna 17, the two loops are configured to look separate from each other.

If the conductive elements 19a and 19b form a closed loop having no opened portions except for a feed portion, an eddy current is produced in such a direction that an effect of a magnetic field produced, if the antenna 17 is excited, around the antenna 27 may be canceled. The eddy current may weaken the coupling between the antennas 17 and 27, and may disturb the contactless communication between the antennas 17 and 27. In order to prevent such a problem, the conductive elements 19a and 19b form the loop having the opened portions.

FIG. 11 is a plan view showing an example of relative positions among the antenna 17, one conductive element shaped circular having an opened portion 19a, and the antenna 27 in a same manner as in FIG. 6. The reason why the conductive element 19a does not form a closed loop is same as in the case of FIG. 10.

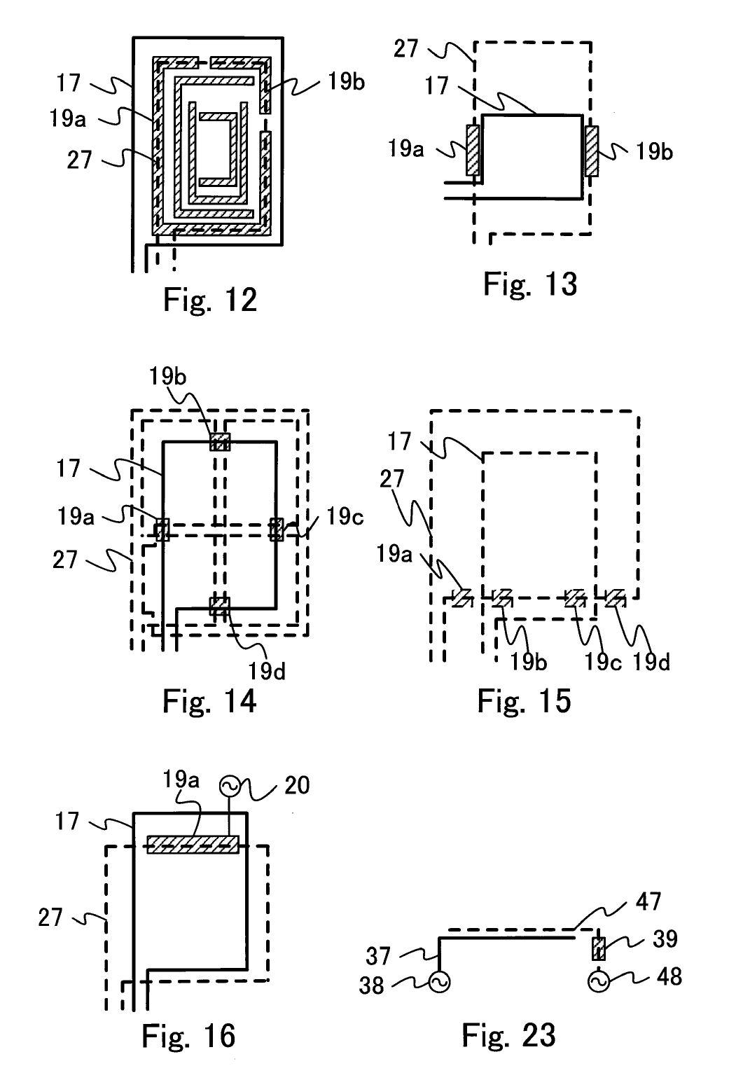

FIG. 12 is a plan view showing an example of relative positions among the components shown in FIG. 10 plus a plurality of conductive elements arranged inside the conductive elements 19a and 19b, in a same manner as in FIG. 6. The effect of suppressing the coupling between the antennas 17 and 27 may be almost uniformly enhanced by the plural conductive elements arranged almost in every direction.

FIG. 13 is a plan view showing an example of relative positions among the components including the conductive elements 19a and 19b arranged at two portions where the antennas 17 and 27 come closest to each other. FIG. 14 is a plan view showing an example of relative positions among the components including the conductive elements 19a-19d arranged at four portions where the antennas 17 and 27 come closest to each other. FIG. 15 is a plan view showing another example of relative positions among the components including the conductive elements 19a-19d arranged at four portions where the antennas 17 and 27 come closest to each other.

FIG. 16 is a plan view showing a same configuration as shown in FIG. 9 in which the conductive element 19a is connected to a feed portion 20. Being connected to a circuit included in the mobile communication apparatus 1, the feed portion 20 may feed the conductive element 19a, as an antenna, at a frequency higher than the resonant frequency of the antenna 17.

Without affecting the effect of suppressing the frequency split at the resonant frequency of the antenna 17, the mobile communication apparatus 1 may be used for another function at another frequency in the configuration shown in FIG. 16. Any one of the configurations shown in FIGS. 6-15 may be so modified that the conductive elements 19a, 19b and so on may be excited at a frequency higher than the resonant frequency of the antenna 17.

Then, an outcome of an experiment to verify an effect of the first embodiment will be explained. Conditions of the experiment are as follows. The portions of the first embodiment described above are arranged in a manner similar to the arrangement shown in FIGS. 5-6. The antenna 17 is like a rectangle 72 by 47 millimeters (mm). The antenna 27 is like a rectangle 47 by 22.5 mm. The magnetic material sheet 18 is like a rectangle 54 by 38 mm provided with the conductive elements 19a and 19b stuck to a surface of the magnetic material sheet 18. The conductive elements 19a and 19b are about 50 mm long in a lengthwise direction each. A magnetic material sheet 18 provided with no conductive elements is prepared for comparison with the magnetic material sheet 18 provided with the conductive elements 19a and 19b.

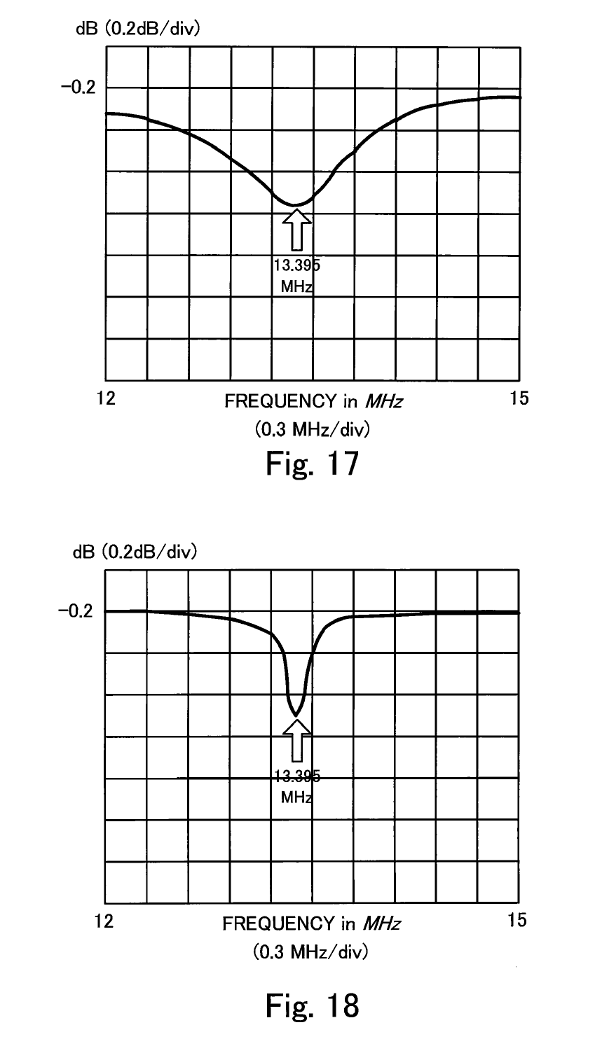

The resonant circuit including the antenna 27 is configured to be resonant at 13.395 MHz. FIG. 17 is an example of a measured frequency characteristic of an S-parameter (S11) of the resonant circuit alone. FIG. 17 has a horizontal axis representing frequencies (in MHz) in a range of 12-15 MHz. FIG. 17 has a vertical axis representing S11 (in decibel (dB)) with a reference level of −0.2 dB and a scale of 0.2 dB/div. The above setting of the horizontal and vertical axes of FIG. 17 will also be applied to FIGS. 18-21 shown later.

In FIG. 17 (and also in the following FIGS. 18-21), a frequency corresponding to a minimum (or local minimum) value of S11 is the resonant frequency. It is shown, as described above, that the resonant frequency is 13.395 MHz.

The resonant circuit including the antenna 17 is configured to be resonant at 13.395 MHz (the conductive elements 19a and 19b have a dimension corresponding to about one 450th of the resonant frequency). FIG. 18 is an example of a measured frequency characteristic of an S-parameter (S11) of the resonant circuit alone. It is shown, as described above, that the resonant frequency is 13.395 MHz.

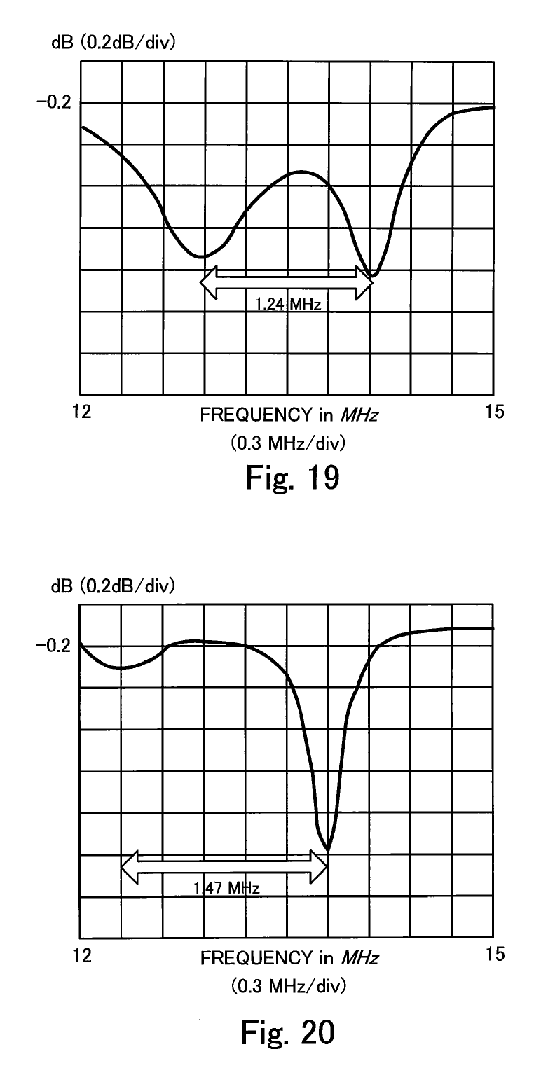

In the above conditions and in a case where the magnetic material sheet 18 is omitted and the antenna 17 faces and approaches the antenna 27, two resonant frequencies 12.89 MHz and 14.13 MHz appear due to a frequency split. FIG. 19 shows an example of a measured frequency characteristic of S11 in that case. The two resonant frequencies have a difference of 1.24 MHz.

Next, in the above conditions and in a case where the magnetic material sheet 18 without the conductive elements 19a and 19b is added, the two resonant frequencies decrease to 12.315 MHz and 13.785 MHz each due to an effect of the magnetic material sheet 18. FIG. 20 shows an example of a measured frequency characteristic of S11 in that case. The two resonant frequencies have a difference of 1.47 MHz.

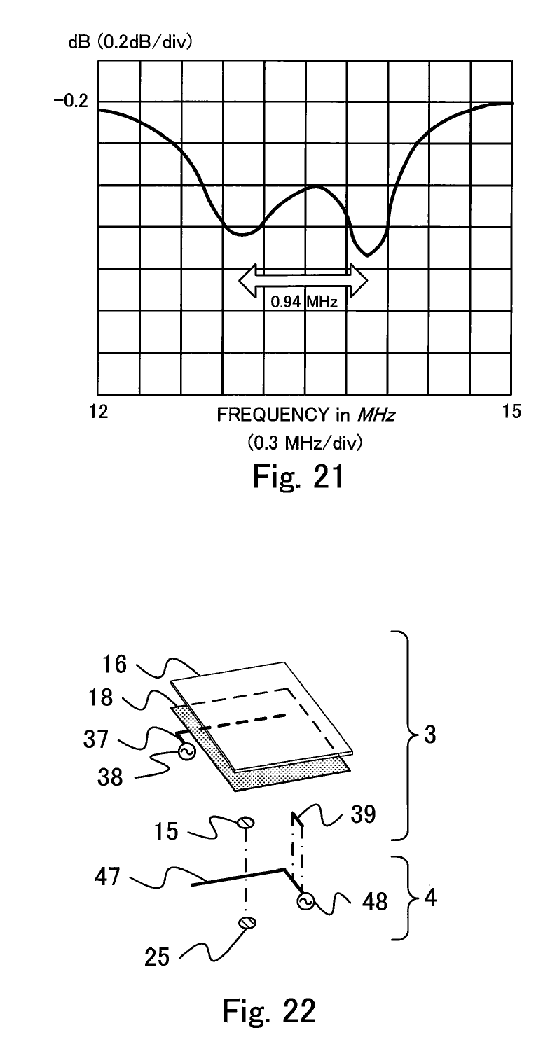

Further, in the above conditions plus a condition that the magnetic material sheet 18 is provided with the conductive elements 19a and 19b stuck to the magnetic material sheet 18, the two resonant frequencies become 13.035 MHz and 13.972 MHz each. FIG. 21 shows an example of a measured frequency characteristic of S11 in that case. The difference between the two resonant frequencies is reduced to 0.94 MHz. The outcome of the experiment proves an effect of suppressing the frequency split due to the conductive elements 19a and 19b having a dimension of about one 450th wavelength.

According to the first embodiment of the present invention described above, if facing and approaching a reader/writer at a determined position, the mobile communication apparatus may suppress a frequency split between resonant circuits of the mobile communication apparatus and the reader/writer due to the conductive elements arranged at a position approaching and coupled to an antenna of the reader/writer.

A second embodiment of the present invention will be described with reference to FIGS. 22-23. The mobile communication apparatus 1 of the first embodiment is partially modified to be a mobile communication apparatus 3, i.e., a radio apparatus of the second embodiment. The reader/writer 2 of the first embodiment is partially modified to be a reader/writer 4, i.e., an external device that the mobile communication apparatus 3 may be arranged opposite.

The mobile communication apparatus 3 may be used being opposite the reader/writer 4, as the mobile communication apparatus 1 is opposite the reader/writer 2 as shown in FIG. 4. Each of portions of the mobile communication apparatus 3 and the reader/writer 4 which is a same as the corresponding one of the mobile communication apparatus 1 and the reader/writer 2, respectively, is given a same reference numeral.

FIG. 22 is a perspective view showing a configuration of and relative positions among main portions of the mobile communication apparatus 3 and the reader/writer 4 in a same manner as in FIG. 5 of the first embodiment. As shown in FIG. 22, the mobile communication apparatus 3 includes an antenna 37 of a monopole type with an open end having replaced the loop-shaped antenna 17 of the first embodiment shown in FIG. 5. The antenna 37 is connected to a feed portion 38 of the mobile communication apparatus 3.

The antenna 37 may be formed by, e.g., a conductive pattern of a flexible printed board, or by using another method. The antenna 37 is entirely or at least partially arranged parallel to the rear face of the first section 11 (not shown in FIG. 22).

A conductive element 39 made of conductive material and shaped as a line or a plane is provided, e.g., on the inner back face of the rear face of the first section 11. The conductive element 39 may be arranged between the rear face of the first section 11, or the antenna 37, and the magnetic material sheet 18, as the conductive element 19a and so on of the first embodiment.

As shown in FIG. 22, the reader/writer 4 includes an antenna 47 of a monopole type with an open end having replaced the loopshaped antenna 27 of the first embodiment shown in FIG. 5. The antenna 47 is connected to a feed portion 48 of the reader/writer 4. The antenna 47 is entirely or at least partially arranged parallel to the rear face of the first section 11 of the mobile communication apparatus 3 in a case where the mobile communication apparatus 3 is arranged opposite the reader/writer 4 in a same manner as shown in FIG. 4.

In FIG. 22, an upper and lower relation between the antenna 37 and the conductive element 39 may be inverted in some cases, in a same manner as described with respect to the first embodiment. At any rate, the conductive element 39 is arranged between the antenna 47 and the magnetic material sheet 18.

FIG. 23 is a plan view showing relative positions among the antenna 37, the conductive element 39 and the antenna 47 shown in FIG. 22 as viewed from just above the printed board 16 in FIG. 22 (i.e., the antenna 47 is viewed from the antenna 37 in a direction perpendicular to the rear face of the first section 11). In that case, as shown in FIG. 23, the conductive element 39 looks like at least partially overlapping the antenna 47, and looks at least partially separate from the antenna 37.

As the conductive element 39 is arranged to look like overlapping the antenna 47, energy transferred between the antennas 37 and 47 through an electric field is partially dissipated as resonant power of the conductive element 39, so that the frequency split between the antennas 37 and 47 may be effectively suppressed. The conductive element 39 has to have dimensions large enough to cause such a resonance, presumably in a range of one tenth to a half wavelength of the resonant frequency (i.e., from of a miniature loop antenna to of a dipole antenna) of the antennas 37 and 47.

According to the second embodiment of the present invention described above, an effect of suppressing the frequency split may be obtained between antennas configured to perform radio transmission through an electric field by using conductive elements so as to weaken a coupling to each other.

In the above description of the embodiments, the configurations, shapes, dimensions, connections or relative positions of the antennas and the other portions, the conditions of the experiment and so on are considered as exemplary only, and thus may be variously modified within the scope of the present invention.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is

1. A radio apparatus configured to perform contactless communication with an external device having a first antenna, upon being arranged opposite the external device, comprising:
a case having an outer face arranged opposite the external device upon the radio apparatus being arranged opposite the external device;
a second antenna provided in the case, the second antenna at least partially arranged parallel to the outer face; and
a conductive element arranged close to and electrically coupled with the first antenna, upon the case being positioned opposite the external device so that the contactless communication may be performed.

2. The radio apparatus of claim 1, wherein
the outer face and at least a portion of the first antenna are arranged parallel to each other, upon the case being positioned opposite the external device so that the contactless communication may be performed, and
the conductive element is arranged in such a way that at least a portion of the conductive element looks like overlapping at least a portion of the first antenna, as viewed from the second antenna to the first antenna in a direction perpendicular to the outer face.

3. The radio apparatus of claim 1, wherein
the outer face and at least a portion of the first antenna are arranged parallel to each other, upon the case being positioned opposite the external device so that the contactless communication may be performed, and
the conductive element is arranged in such a way that at least a portion of the conductive element looks separate from the first antenna, as viewed from the second antenna to the first antenna in a direction perpendicular to the outer face.

4. The radio apparatus of claim 1, wherein the conductive element is formed on a face of the case.

5. The radio apparatus of claim 1, wherein the conductive element is sized in such a range as to be resonant with a frequency of the contactless communication with the external device.

6. The radio apparatus of claim 1, wherein the conductive element is sized large enough to cause a significant level of eddy current loss at a frequency of the contactless communication with the external device.

7. The radio apparatus of claim 1, further comprising a magnetic material sheet, wherein the conductive element is arranged between the first antenna and the magnetic material sheet upon the case being positioned opposite the external device so that the contactless communication may be performed.

8. The radio apparatus of claim 1, wherein
the first antenna is loop-shaped,
the second antenna is loop-shaped, and
the conductive element is shaped as a line or a plane.

9. The radio apparatus of claim 1, wherein
the first antenna is loop-shaped,
the second antenna is loop-shaped, having a first area;
the conductive element is loop-shaped, having a second area being different from the first area.

10. The radio apparatus of claim 1, further comprising an exciting unit configured to excite the conductive element at a frequency higher than a frequency of the contactless communication.

11. The radio apparatus of claim 1, further comprising an auxiliary unit configured to help in positioning the case opposite the external device so that the contactless communication may be performed.

12. An antenna device adapted for a radio apparatus configured to perform contactless communication with an external device having a first antenna upon being arranged opposite the external device, the radio apparatus including a case having an outer face arranged opposite the external device upon the radio apparatus being arranged opposite the external device, comprising:
a second antenna provided in the case; and
a conductive element arranged close to and electrically coupled with the first antenna, upon the case being positioned opposite the external device so that the contactless communication may be performed.

13. The antenna device of claim 12, wherein
the outer face and at least a portion of the first antenna are arranged parallel to each other, upon the case being positioned opposite the external device so that the contactless communication may be performed, and
the conductive element is arranged in such a way that at least a portion of the conductive element looks like overlapping at least a portion of the first antenna, as viewed from the second antenna to the first antenna in a direction perpendicular to the outer face.

14. The antenna device of claim 12, wherein
the outer face and at least a portion of the first antenna are arranged parallel to each other, upon the case being positioned opposite the external device so that the contactless communication may be performed, and
the conductive element is arranged in such a way that at least a portion of the conductive element looks separate from the first antenna, as viewed from the second antenna to the first antenna in a direction perpendicular to the outer face.

15. A radio communication system, comprising:
a first radio apparatus having a first antenna; and
a second radio apparatus including a case, a second antenna provided in the case, and a conductive element arranged to be close to and electrically coupled with the first antenna, upon the case being positioned opposite the first radio apparatus so that contactless communication may be performed with the first radio apparatus.
